(19) United States
(12) Patent Application Publication
(10) Pub. No.: US 2026/0101198 A1
(43) Pub. Date: Apr. 9, 2026

(54) METHODS AND APPARATUS ENABLING ADVANCED AND ADAPTIVE WIRELESS TRANSMIT/RECEIVE UNIT (WTRU) TRACKING FOR NEXT GENERATION MOBILE SYSTEMS

(71) Applicant: InterDigital Patent Holdings, Inc., Wilmington, DE (US)

(72) Inventors: Michel ROY, Candiac (CA); Ulises OLVERA-HERNANDEZ, Saint-Lazare (CA); Michael STARSINIC, Newtown, PA (US); Saad AHMAD, Montreal (CA); Mohamad Kenan AL-HARES, Canterbury (GB); Zhibi WANG, Woodridge, IL (US)

(73) Assignee: InterDigital Patent Holdings, Inc., Wilmington, DE (US)

(21) Appl. No.: 18/905,867

(22) Filed: Oct. 3, 2024

(51) Int. Cl. H04W 24/02; H04W 8/22; H04W 64/00; H04W 84/12

(52) U.S. Cl. CPC H04W 24/02; H04W 8/22; H04W 64/00; H04W 84/12

(57) ABSTRACT

A first wireless receive and transmit unit (WTRU) may send, to a network, WTRU tracking and reachability (TR) information. The WTRU TR information may comprise WTRU tracking capabilities or WTRU tracking information. The WTRU tracking capabilities may include at least one of: self-tracking capability, capability of tracking from an alternate source, including the identification of the alternate source, or capability to track a second WTRU, including the identification of the second WTRU. The first WTRU may receive, from the network, WTRU TR configuration. The WTRU TR configuration may include identification of an alternate source of WTRU tracking information and a condition to trigger the WTRU to provide tracking information to the alternate source of WTRU tracking information. Upon determining that the condition is met, the WTRU may send, to the alternate source, WTRU tracking information.

### BACKGROUND

Paging functionality is an important functionality that enables a network to trigger a device to establish communication with a network, either to provide control information, or to establish a protocol data unit (PDU) session. In the example of a 5G network, the paging is based on the network knowing a sub-set of cells the device is in. This subset of cells is referred to as a tracking area (TA), and while the device stays in that TA, the network may page the device only in the cells belonging to that TA.

In the example of a 5G network, the access and mobility function (AMF) may manage WTRU mobility and tracking via the WTRU registration, WTRU session management and WTRU location updates. When a WTRU moves to a different TA, the WTRU may inform the AMF. This information may be used by the network when paging a WTRU for incoming calls or data connectivity. Network operators may vary the size of a TA, as a function of the load of the cells and the acceptable latency to establish the connection.

### SUMMARY

Enhancements to network architecture and associated procedures are described herein. The enhancements may provide opportunities to address user reachability challenges by providing new capabilities. The network may provide a new tracking and reachability service via a new tracking and reachability function (TRF). In the example of a 6G network or next generation network, the TRF architecture may decouple the tracking functions from the access and mobility function (AMF), therefore simplifying the AMF operation.

The TRF architecture and procedures may allow a WTRU to be tracked via alternate sources that were not previously supported. The architecture may allow a WTRU to provision tracking information to enable new tracking capabilities within the network. The procedures may provide capabilities for tracking a WTRU via new tracking sources. Providing new tracking sources may improve the precision of the WTRU location, which in turn may improve the WTRU reachability performance of the network.

The architecture enhancement may facilitate artificial intelligence/machine learning (AI/ML) assisted WTRU tracking in the network. The network may use the available information and knowledge about a given WTRU to determine frequency and methods to track the WTRU. This may improve the tracking predictions of the network by integrating new tracking sources for training AI/ML tracking models. The solutions described herein define functions and information flows needed to provide advanced and adaptive WTRU tracking for next generation mobile systems.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example architecture of a core network architecture including a Tracking and Reachability Function (TRF);

FIG. 3 illustrates two models of the tracking and reachability (TR) provisioning procedures between a WTRU and a TRF: a registration model and an SBI model;

FIG. 4 illustrates an example of a WTRU tracking procedure via WTRU reporting;

FIG. 5 illustrates an example of a WTRU tracking procedure via alternate sources; and

FIG. 6 illustrates an example of a tracking and reachability (TR) procedure when using an alternate source of WTRU tracking.

### DETAILED DESCRIPTION

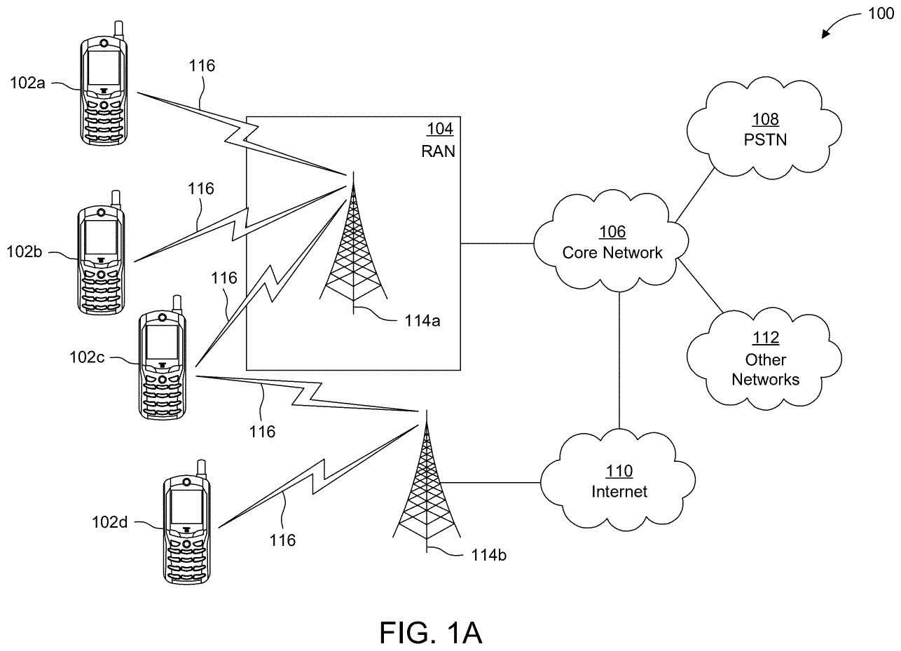

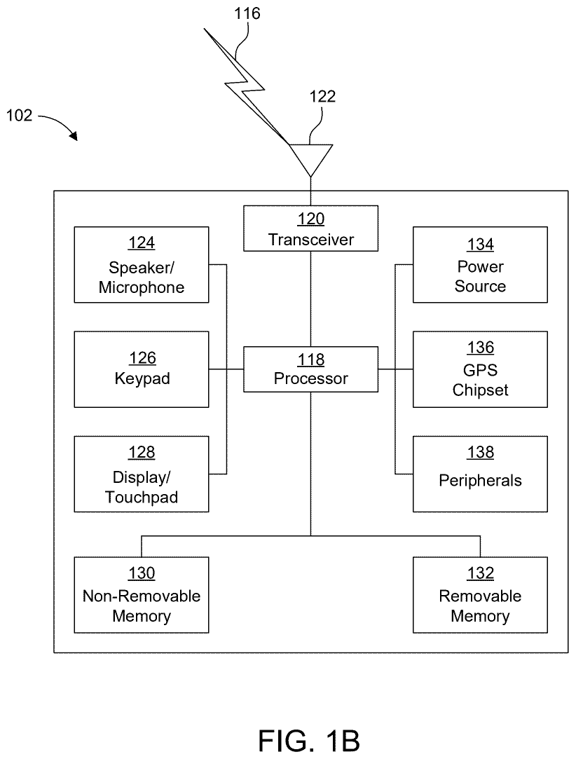

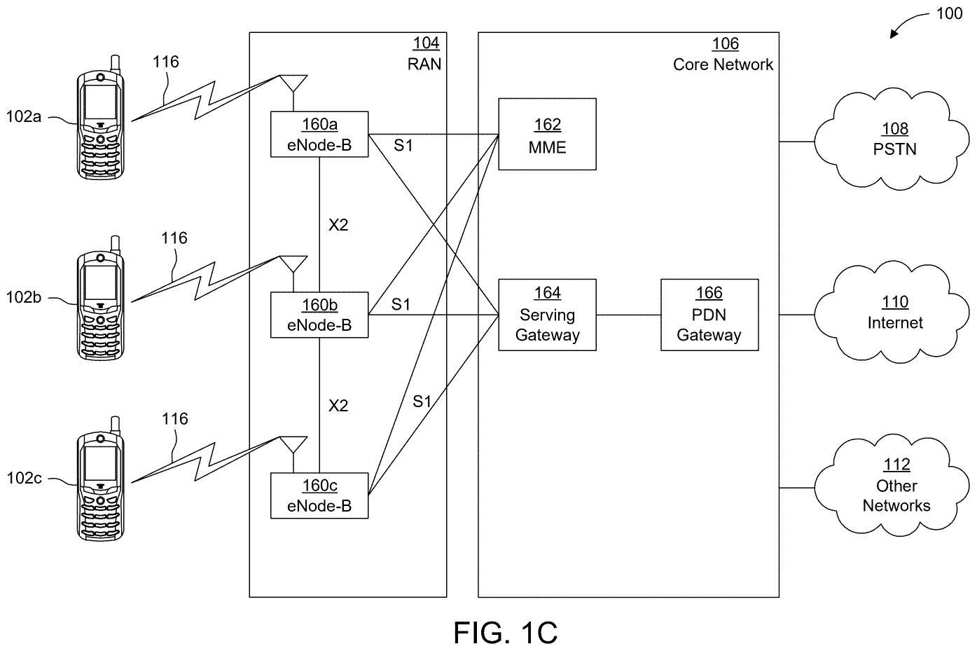

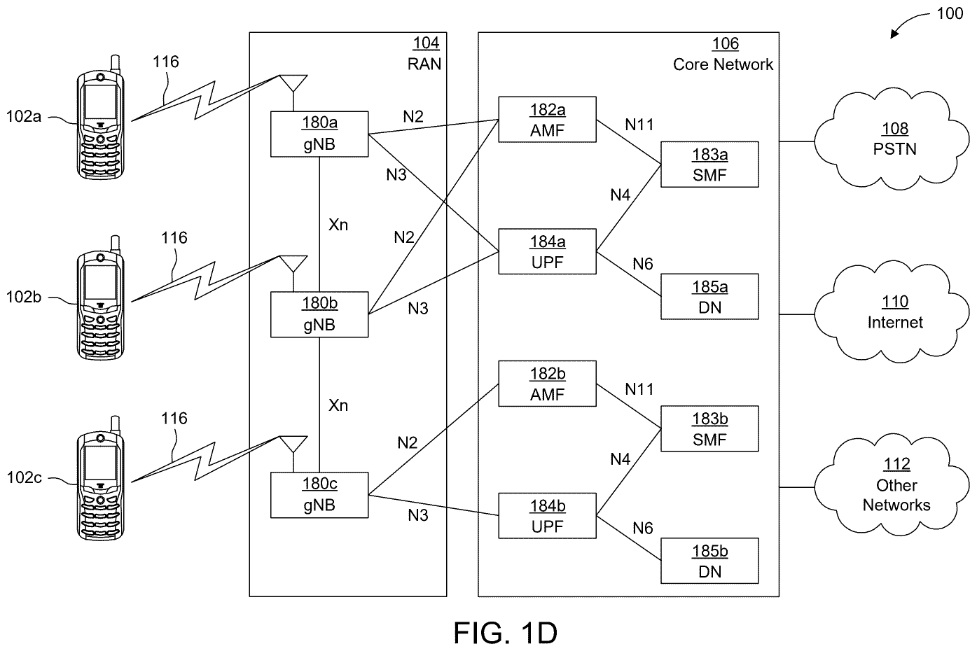

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### WTRU Paging in 5G

In an example of a 5G mobile network, paging a WTRU is the process used to alert or locate a WTRU that is in idle state (e.g., not actively engaged in a data session or call). Paging is necessary when the network needs to establish communication with the WTRU and the WTRU is in an IDLE state, for example when there is an incoming call or downlink data needs to be sent to the WTRU, and a signaling connection and user plane resources need to be established to handle data transfer. In the example of a 5G network, the following steps may be involved in a paging procedure.

In a first step, paging may be initiated when the network needs to reach a WTRU in idle state. Paging is typically initiated by a core network component or Network Function such as the Access and Mobility Function (AMF) or Session Management Function (SMF) or even the Policy Control Function (PCF), Unified Data Management (UDM) entity or the Location Management Function (LMF), depending on the nature of the data (e.g., control information or data). A paging request or message may be formed and include information such as a WTRU identifier (e.g., TMSI or IMSI) and an event type (e.g., incoming call, SMS, data, etc.) and it may include parameters used by the Access Node to execute its paging strategy, e.g., 5QI and ARP.

In a second step, the paging message is sent to an Access Network (AN) that broadcasts the paging signaling according to a paging strategy; the Access Network(s) may be associated with gNodeB(s) and determined based on a WTRU's last known location or Tracking Area (TA). The determination of the AN(s) and gNodeB(s) for performing paging broadcast signaling needs to happen in a balanced manner since paging resources in a network and at a gNodeB are limited. In a first example of unbalanced paging approach, broadcasting paging signaling in all gNodeB would waste network paging resources and provide high odds with minimized delay for reaching a WTRU. In a second example of unbalanced paging approach, broadcasting paging signaling one gNodeB at a time would preserve network paging resources and provide low odds with possible long delays for reaching a WTRU.

In a third step, the WTRU in idle mode listens to the designated paging channel of the gNodeB where it is camped. When a paging message is received, a WTRU determines if the paging message is intended for the WTRU. The WTRU responds to the paging message if the paging message is intended for the WTRU; the response message may be a NAS Service Request message that may indicate WTRU readiness to establish communication.

In a fourth step, AMF receives the Service Request Message which triggers procedures to establish the communication session.

Paging resources relates to paging channel capabilities of the network. Paging messages are broadcasted over the network and paging resources are limited, therefore efficiently managing the paging traffic is necessary to avoid congestion.

Paging latency relates to the time between the paging initiation at the core network (e.g., the first step) and the establishment of communication with the WTRU (e.g., fourth step). The paging decisions or algorithm (e.g., the second step) directly influences paging latency, which in turn influences how quickly the user is informed of incoming communications and user experience.

Paging power consumption is related to the battery power that is needed to analyze paging traffic received at the WTRU. The WTRU may be in idle mode to preserve power, but it still needs to listen to paging messages sent on the paging channel of the gNodeB (gNB) it is camped on. The frequency of paging occasions when a page is sent on the paging channel may influence WTRU battery life due to the constant need to trigger processing mechanisms in the WTRU to analyze paging messages.

Paging efficiency relates to odds of reaching a WTRU when paging. If a WTRU in idle mode is located in a poor coverage area or if a WTRU moves out of a tracking area, where the initial paging attempt took place, thereby causing a subsequent attempt extending the paging area, the paging efficiency may decrease, resulting in higher latency to reach a WTRU and higher network paging resource consumption.

Paging scalability relates to the capability of the network to handle a high volume of WTRUs and high volumes of paging messages. When congestion happens on the paging channel, it may become impossible or inefficient to page a WTRU, resulting in missed calls, data session timeout and poor user experience.

### WTRU Location Tracking

As described in the previous paragraphs, the WTRU paging process is an essential process involving consumption of limited network resources (e.g., the paging channel) and impacting the WTRU and user in various ways (e.g., battery life, latency, user experience). The WTRU paging process must be configured in such a way that a balance between network constraints and user experience is constantly maintained.

To achieve a good balance between network constraints and user experience, the WTRU paging process relies on WTRU location tracking information; in other words, the network may be capable of achieving a good balance between network constraints and user experience if the WTRU location tracking information available in the network is accurate and precise.

Using an example of a 5G network, the network coverage is divided in multiple tracking areas (TA); each TA may be composed of a set of cells. A cell or a gNodeB is typically assigned/configured to broadcast a single TA. The WTRU location is tracked based on the current WTRU TA; when a WTRU moves from one TA to another TA, a WTRU location update is triggered to inform the core network of the new WTRU location.

In the example of a 5G network, the Access and Mobility Function (AMF) is responsible for managing WTRU mobility and tracking via the WTRU registration, WTRU session management and WTRU location updates. When a WTRU moves to a different TA, the AMF is informed. This information is used by the network when paging a WTRU for incoming calls or data.

The 5G WTRU may periodically, or upon leaving a registration area, send a registration request to the network to inform the AMF of the WTRU's current location.

WTRU paging and tracking procedures are essential for the operation of the mobile network. WTRU paging may be used for alerting WTRU in IDLE mode about incoming communication. WTRU tracking procedures provide information to the network about the WTRU location. Albeit tracking and paging procedures stand on their own right and may be considered independent, tracking information may be used to influence and enhance the paging performance of the network.

A balanced approach to WTRU paging may be needed to preserve the limited paging resources of the mobile network, while ensuring a good user experience (e.g., incoming communication latency, WTRU battery life). WTRU paging and tracking capabilities in the 5G core network may be limited by several factors: characteristics of the network design (e.g., TA allocations), by the reporting capabilities of the WTRU (e.g., TA reporting) and by determined WTRU paging algorithms which are based on TA allocations and TA reporting. As such, it may be difficult to design WTRU paging algorithms that provide a balanced approach for all possible network topologies and in all possible network conditions.

In the example of a 5G core network, WTRU paging and tracking capabilities are provided by the AMF, which is a complex functional entity responsible of multiple operational aspects of the mobile network. Due to its complexity, there may be resistance to evolving the AMF to improve WTRU paging and tracking. There may also be a significant desire to decentralize functionality from the AMF into specialized functions; as such, WTRU paging and tracking may be considered as candidate functionality for a decentralized specialized function.

A first challenge may be related to defining a new core network architecture and associated procedures that provides new WTRU tracking functionality in an evolved standalone function. A second challenge may be related to defining a WTRU tracking evolution for enhancing WTRU localization and improve WTRU paging performance.

The tracking and reachability information is comprised of information about a WTRU identity, a WTRU location and a WTRU reachability that may be stored in the TRF and/or the unified data management (UDM)/unified data repository (UDR).

WTRU tracking capabilities (WTRUTC) may provide information about capabilities of a WTRU location tracking. WTRUTC may be used by the TRF to determine tracking strategies related to a WTRU. In one example, WTRUTC may indicate whether a WTRU supports reporting tracking information to the TRF and may include information about the tracking information reporting, for example the reporting frequency.

In another example, WTRUTC may provide information about the capabilities of a WTRU for determining self-tracking information; for example, WTRUTC may indicate that the WTRU supports reporting GPS tracking information, WIFI tracking information (e.g., sensed SSIDs and/or ANQP information and/or connected SSID), Bluetooth tracking information (e.g., sensed Bluetooth beacons and/or advertised Bluetooth information), or tracking using Ranging. The WTRUTC may also indicate whether the tracking information is intended for data collection, E.g., for AIML-based positioning services. The WIFI and/or Bluetooth tracking information may be used in conjunction with a map to help localize a WTRU based on the nearby WIFI and/or Bluetooth signals sensed by a WTRU.

In another example, WTRUTC may provide information about the capabilities of a WTRU for being tracked by alternate sources. For example, WTRUTC may indicate that it supports ambient IoT technology that may be used by the network to trigger (e.g., energize) an ambient Internet of things (aIoT) device of the WTRU for reporting the WTRU tracking information (e.g., a location). In another example, the WTRUTC may indicate that a tracking application function (AF) may provide precise tracking information about a WTRU. In another example, the WTRUTC may indicate that a second WTRU, and a third WTRU as a reference WTRU, can be used to report the position of a WTRU; in other words, a first WTRU (e.g., a passenger's phone) may indicate in WTRUTC that a second WTRU (e.g., a car) can report the position of the first WTRU. In another example, the WTRUTC may indicate that an interworking gateway (e.g., N3IWF/TNGF/TWIF/W-AGF) used by a WTRU may provide tracking information about a WTRU. Examples of interworking gateways include

In another example, WTRUTC may provide information about the capabilities of a WTRU for tracking other WTRUs; for example, WTRUTC may indicate that the WTRU is acting as a mobile hotspot and can provide tracking information on connected WTRUs. In another example, WTRUTC may indicate that the WTRU is acting as a Prose relay and can provide tracking information on WTRUs using the relay. In a final example, WTRUTC may indicate that the WTRU is capable of sensing WTRUs in proximity and provide tracking information on sensed WTRUs.

WTRU Connectivity Information (WTRUCI) may provide information about the connectivity supported for tracking a WTRU. The TRF may use the WTRU connectivity information when determining a tracking strategy for a WTRU. The WTRU connectivity information may include, for instance, the WTRU IP address, the WTRU interworking gateway information (e.g., identifier and address of the gateway), AF information (e.g., URL, URI, IP address, AF identifier) of an AF associated with the WTRU, personal IoT network (PIN) information (e.g., PIN identifier, PIN server endpoint, PIN element with gateway capabilities (PEGC) IP address, PIN element with management capabilities (PEMC) IP addresses) of a PIN where the WTRU is member, aIoT information (e.g., aIoT device identifier and triggering information) for triggering an aIoT device associated with a WTRU, proximity services (Prose) relay information (e.g., IP address) of a Prose relay used by the WTRU.

A WTRU Identifier (WTRUID) may identify a WTRU.

WTRU Tracking Information (WTRUTI) may provide information about the WTRU location and/or information about alternate sources for obtaining the WTRU location based on WTRUTC. The TRF may use the WTRUTI to update the WTRU current WTRU location and/or to obtain the WTRU location from an alternate source. For example, the WTRUTI may contain the GPS coordinates, a list of sensed SSIDs and information about a location AF for precise WTRU positioning; the TRF may use the GPS location as a coarse WTRU location, may use a SSID map with the sensed SSIDs to obtain a finer location, and may contact an AF to obtain a fine location.

WTRUTI may also provide information about the WTRU location and required tracking update frequency and whether the WTRU has low mobility characteristics in certain locations or in certain times of day or in when serving certain application. In other words, whether the WTRU is likely to change its location during certain time of the day or when serving certain applications or in certain geographical areas.

The WTRU Tracking Configuration may provide information related to WTRU tracking that can be used by the TRF. For example, the WTRU tracking configuration may be a tracking information reporting frequency and/or conditions where the WTRU can send tracking reports. For example, the WTRU tracking configuration may indicate to the TRF to obtain tracking information from alternate sources at a frequency and/or in certain conditions. The WTRU tracking configuration may also indicate how to obtain WTRU tracking information from alternate sources; for example, when using an AF as an alternate source, the WTRU tracking configuration may include the credentials/tokens to obtain information from the alternate source.

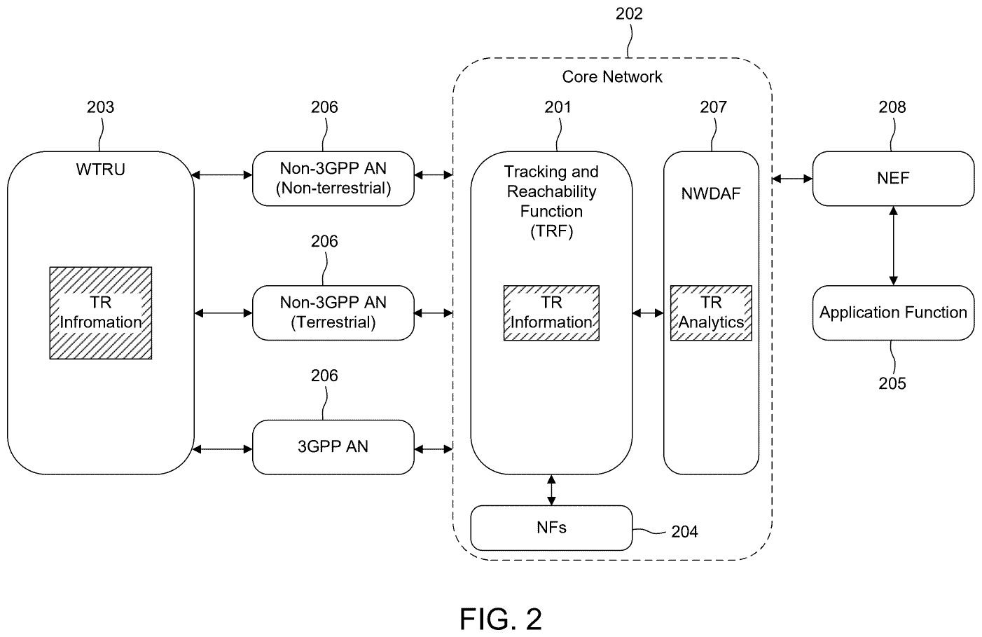

FIG. 2 illustrates an example architecture of a core network architecture including a Tracking and Reachability Function (TRF).

In this example, the tracking and reachability function (TRF) 201 may be a functional entity within the core network 202 of a mobile network or interacting with the core network 202 of a mobile network. The TRF 201 may be part of a service based architecture (SBA) and may provide a functionality through an interface or an API. The TRF may implement functionality for tracking a WTRU 203 or for providing information about a WTRU 203 location. The TRF may implement functionality for reaching a WTRU 203 for informing a WTRU 203 about incoming communications (e.g., call or data). The TRF may send or receive messages to/from a WTRU 203, a network function (NF) 204 within the core network of a mobile network, an application function (AF) 205 outside the core network 202 of a mobile network, or an access network (AN) 206 interacting with the core network 202 of a mobile network.

The TRF 201 may discover WTRU 203 with the TRF capability, may collect/store/maintain WTRU tracking information, may configure a network data analytics function (NWDAF) 207 to infer WTRU tracking predictions, may provide WTRU tracking information to a requestor.

In the example of a 5G core network 202, the NWDAF 207 is a network function that collects, analyzes and utilizes data from various sources to enhance performance and management of the network. The NWDAF may be enhanced to interact with the TRF 201 to provide predictions specific to WTRU tracking.

The network functions (NFs) 204 and application functions (AF) 205 may consume services from the TRF201, for example, to obtain or to provide WTRU tracking information. Interactions with the TRF 201 may be direct or indirect, for example a NF 204 within the core network 202 may interact directly with the TRF 201, while an untrusted AF 205 may interact indirectly via a network exposure function (NEF) 208.

The access network (AN) 206 may enable the core network 202 to interact with the radio access network (RAN). Multiple ANs 206 may be available to the core network 202 and the AN 206 may be for different access technologies. In one example, an AN may allow the core network to interface with a cellular network, a non-terrestrial network (NTN) or satellite network, or a WIFI network.

It can be appreciated that non-3GPP networks may require a non-3GPP gateway function to interface to the core network. For example, the non-3GPP interworking function (N3IWF) may be deployed as a network function and may be responsible for interworking between an untrusted non-3GPP network and the core network. Other examples of interworking gateways include trusted non-3GPP gateway function (TNGF), trusted WLAN interworking function (TWIF), or wireline access gateway function (W-AGF).

The WTRU may consume services from the TRF, for example, to obtain or to provide WTRU tracking information. WTRU interactions with the TRF may occur using the Non-Access Stratum (NAS) protocol. The NAS payload may be transported over service based interfaces (SBI), or over dedicated point to point interfaces (e.g., N2), dependent on the WTRU and network deployment and capabilities.

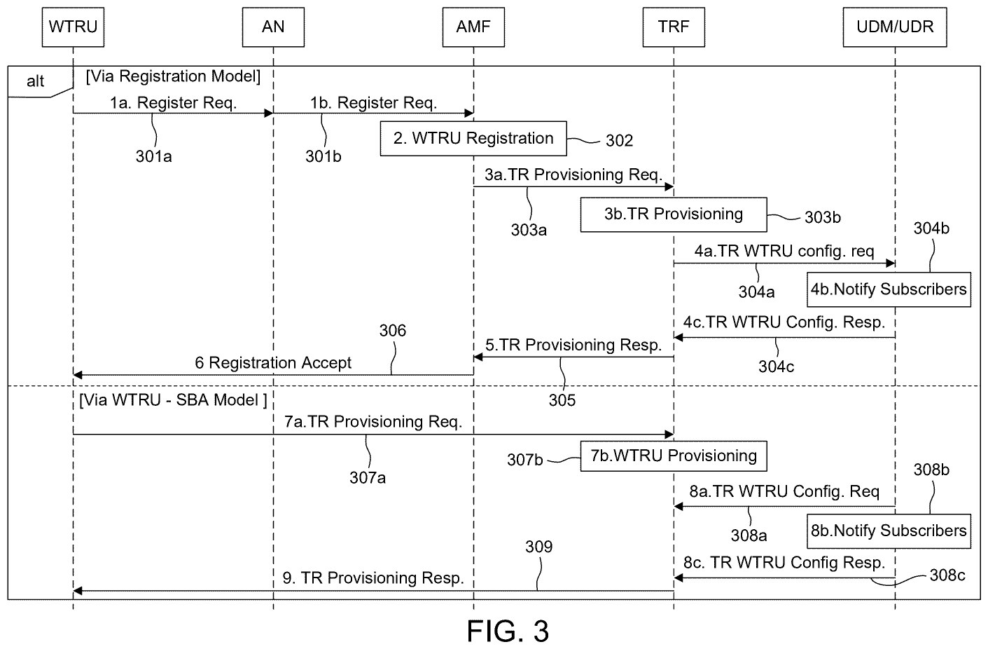

FIG. 3 illustrates two models of the tracking and reachability (TR) provisioning procedures between a WTRU and a TRF: a registration model and an SBI model.

Steps 1a, 301a to 6, 306 illustrate one example of TR provisioning using a registration model. Steps 7a, 307a to 9, 309 illustrate another example of TR provisioning using an SBI model.

### Registration Model

In step 1, the WTRU registers to the mobile network. The WTRU may send a registration request 301a to the AN and the AN may select an AMF and forward the registration request 301b to the selected AMF. The registration request may include TR information, which was described in previous paragraphs.

In step 2, the AMF performs WTRU registration 302, which may include selection of various NF (e.g., AUSF, UDM, PCF). The registration 302 may include authorization for the WTRU to use the network. The registration 302 may include transferring the WTRU context information. Additionally, the AMF may select a TRF for handling the tracking and reachability of the WTRU. Selection of the TRF may be based on subscriber profile information, based on the selected AMF, or based on the TR information.

In step 3, the AMF sends a TR provisioning request message 303a to the TRF selected in step 2. The message may include information about the associated AMF and the TR information.

Upon receiving the request, the TRF may perform TR provisioning 303b. The TRF may store the received TR information locally and associate the TR information with the WTRU identity. Additionally, the TRF may perform any of the following actions.

The TRF may determine common tracking capabilities of the WTRU and the TRF. The determination may be based on the WTRUTC included in the request and capabilities configured in the TRF. The TRF may also consider the subscriber's information, the local TRF configuration, and the WTRU location to determine the common set of WTRU tracking capabilities.

The TRF may determine that data analytics services may assist the TRF in determining WTRU tracking strategies. The determination may be based on the determined common tracking capabilities of the WTRU, of the TRF, and on the capabilities provided by the data analytics service.

For example, the TRF may obtain services from a NWDAF, an application data analytics enablement service (ADAES), or an AI/ML enablement (AIMLE) layer, to obtain analytics and/or perform predictive AI/ML tasks related to WTRU tracking.

For example, the TRF may request and/or subscribe to tracking analytics (e.g., with the NWDAF or ADAES) and the request and/or subscription may be based or include TR information, as described in previous paragraphs.

For example, the TRF may discover an AI/ML model (e.g., with an AIMLE) for predicting WTRU tracking; the discovery request may be based or include TR information, as described in previous paragraphs.

For example, the TRF may discover or trigger the deployment of an assistance service (e.g., an edge application server (EAS) or cloud application server (CAS)) and configure the service based on a discovered AI/ML model to perform predictions (e.g., inferences) related to WTRU tracking. The discovery or deployment request of the assistance service may be based or include TR information, as described in previous paragraphs.

For example, the TRF may enroll the WTRU in an AI/ML federated learning process for the purposes of training an AI/ML model based on the WTRU tracking information. The enrolment may be temporary (e.g., until the AI/ML model is trained), and may be based on the WTRU location. For example, the TRF may use the WTRU TR information as training data for an assistance AI/ML model for WTRU tracking and may determine to use the trained model for determining a WTRU tracking predictions or strategy.

In step 4, the TRF sends a TR WTRU configuration request message 304a to the UDM; the message includes the TR information. The UDM may create or update an entry to store the TR information associated with the WTRU in the UDR. If the UDM determines subscribers for tracking and reachability information associated with the WTRU, the UDM may send a notification message 304b to the determined subscribers, including the appropriate information. Then the UDM may send a TR WTRU configuration response message 304c to the TRF. The message may include an identifier for the created or updated entry, and an indication of success or failure.

In step 5, the TRF sends a TR WTRU configuration provisioning response message 305 to the AMF. The message may include an identifier of TR information associated with the WTRU and may include information for communicating with the TRF, such as a TRF identifier, a URL, a URI or endpoint information. The TR information identifier, the TRF identifier and the WTRU identifier may be used to perform management operations (e.g., read, update, delete) on the TR information. The TRF may include the TR information resulting from the capability determination in step 3. Additionally, the TRF may include the desired WTRU tracking configuration information.

In step 6, the TRF may send a registration accept message 306 to the WTRU; the message may include the information from the TR WTRU configuration provisioning response message. Upon receiving the registration accept message containing a TR information identifier and/or a TRF identifier and/or TR information, the WTRU may perform the following actions.

The WTRU may initiate tracking measurements and/or reporting according to TR information provided by the TRF; for example, the WTRU may initiate tracking based on the common tracking capabilities, the WTRUTI and the WTRU tracking configuration.

In an alternative architecture, the TRF function may be deployed as a network service accessible via a service-based interface. The WTRU may discover a TRF service; the TRF service communication information (e.g., URL, URI, endpoint) may have been provided to the WTRU via network registration, or via an explicit discovery request sent to the network.

### SBI Model

In step 7, the WTRU may send a tracking and reachability (TR) provisioning request 307a to the TRF; the request may include TR information, as described in previous paragraphs. Upon receiving the request, the TRF may perform the TR provisioning 307b. This step may be the same as described in step 3b 303b.

Steps 8a, 8b and 8c (308a, 308b, 308c) may be the same as steps 4a 4b and 4c (304a, 304b, 304c).

In step 9, the TRF may send a TR provisioning response 309 to the WTRU. The information included in the response may be the same described in step 5.

As previously mentioned, advanced WTRU tracking may be achieved via tracking reports from a WTRU and from alternate tracking sources. The TRF may be enabled to obtain tracking reports from a WTRU. The TRF may be enabled to obtain tracking reports about a WTRU from alternate tracking sources.

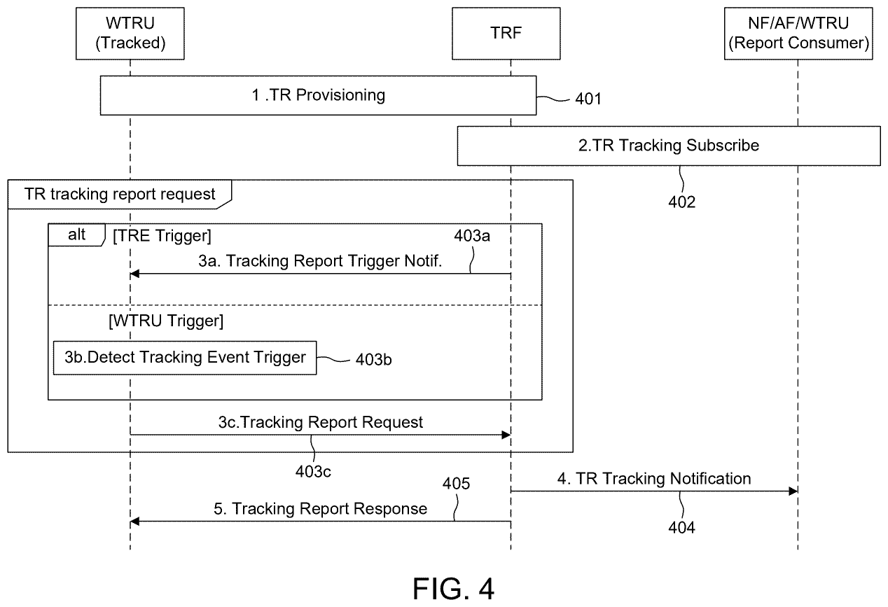

FIG. 4 illustrates an example of a WTRU tracking procedure via WTRU reporting.

A TR provisioning procedure 401 occurs. This procedure may be, for example, one of the procedures described in FIG. 3, e.g., registration model or SBI model.

A TR report consumer subscribes with the TRF 402 by sending a TR tracking subscribe request message. The subscriber may be a network function, an application function or a WTRU, and the request may be sent directly to the TRF or indirectly, for example through the NEF. The TR tracking subscribe message may include a subscriber identifier, authorization information for subscribing with the TRF, notification endpoint information where the TRF may send the TR tracking notification messages, and information about events subscribed for. The information about subscribed events may indicate to the TRF the conditions for detecting events and sending a TR tracking notification to the subscriber. For example, the subscribed events information may indicate to the TRF one or more WTRU identifiers for which the subscription applies; subscribed events information may further indicate that the subscription is for WTRU tracking information. The subscribed events information may further indicate the characteristics associated with the subscribed event, such as a geographical or topological location for which WTRU tracking information should be sent, and whether the subscribed event is for the WTRU entering, exiting or moving within such location.

Upon receiving and authorizing the subscription request message, the TRF may authorize and create a subscription for the subscriber, provide the subscriber with a subscription identifier in a response message such that the subscriber can manage (e.g., update, delete) the subscription, and may start monitoring for WTRU subscribed events according to the subscribed events information.

A WTRU may detect a tracking even trigger. The tracking event may be a trigger/message from the TRF 403a or an internal trigger in the WTRU 403b. In a first example, the TRF may send a tracking report notification 403a to the WTRU based on an internal event such as a timer expiration or receiving a tracking report request from a NF/AF/WTRU. In a second example, the WTRU may determine to trigger the tracking report request by detecting an internal event 403b, such as a timer expiration or a change related to connectivity, geographical or topological location, or a state change related to WTRU self-tracking capabilities (e.g., WTRUTC).

Once triggered, WTRU may send a tracking report request 403c to the TRF. The tracking report request 403c may include any WTRU tracking information or may contain tracking information that is related to the report triggering source. For example, if the TRF triggered the report 403a, the tracking report notification may indicate which tracking information is required by the TRF, and the WTRU may include only the required tracking information in the tracking report request 403c. In another example, if the report is triggered at the WTRU 403b, the tracking report request 403c may include only tracking information related to the event detected at the WTRU.

Upon receiving the tracking report request 403c, the TRF may update the WTRU tracking information at the TRF. The TRF may evaluate if any subscriber for tracking information needs to be notified, based on the newly reported WTRU tracking information. The determination at the TRF for notifying a subscriber may require the TRF to compare the updated tracking information with the subscription information to determine whether the subscriber for WTRU tracking information needs to be informed about the changes.

It can be appreciated that, upon receiving a new tracking report, the TRF may store the WTRU tracking information at the UDM/UDR, and that the UDM/UDR may provide the WTRU tracking information to other NFs that have subscribed for WTRU tracking information with the UDM/UDR.

It can be appreciated that, upon receiving a new tracking report, the TRF may re-evaluate the WTRU tracking strategy based on the received report information and may perform other actions based on the re-evaluation. For example, if the report indicates that the WTRU has connected to an AF capable of reporting WTRU tracking information, the TRF may re-evaluate the tracking strategy accordingly and obtain tracking information from the AF, as an alternate tracking source.

The TRF may send a tracking report response 405 to the WTRU; the response may indicate whether the tracking report request sent in step 3c was successful and may indicate updated TR information and/or the re-evaluated tracking strategy as just explained in the previous paragraph.

It can be appreciated that the TR subscription and notification procedure described in step 2, 402 and step 4, 404 may be achieved following a request/response model. For instance, the request message may include information as described for the subscription request in step 2, 402. The response message may include information as the notification message described in step 4, 404. The TRF may determine to trigger a tracking report trigger notification upon receiving such request, and the TRF may include information in the response based on internal tracking information and/or based on a triggered tracking report request 403c.

It can be appreciated that the tracking report triggering and reporting described in step 3, 403a, 403b, 403c and step 5, 405 may be achieved using the NAS protocol.

The TR provisioning information may indicate in the WTRUTC that a WTRU supports tracking via one or more alternate tracking sources, such as an interworking gateway, an AF, a PEGC, a PEMC, a tracking WTRU or via aIoT.

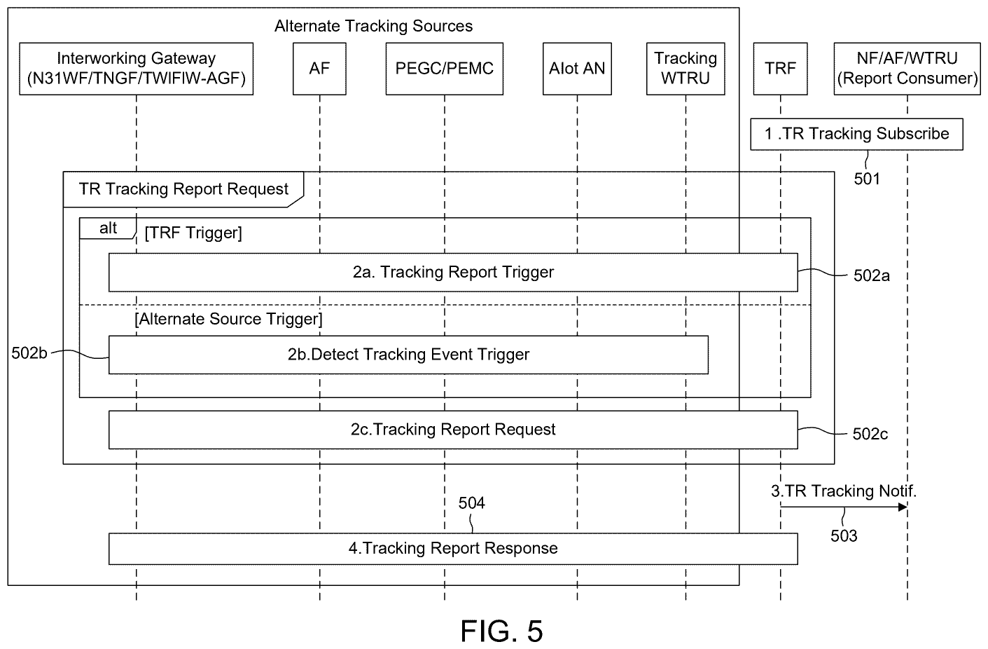

FIG. 5 illustrates an example of a WTRU tracking procedure via alternate sources.

A tracking and reachability (TR) report consumer subscribes with the TRF 501 by sending a TR tracking subscribe request message, as it was described in the previous example.

An alternate tracking source may send a tracking report request 502c to the TRF if a tracked WTRU has indicated support for one or more alternate tracking source in the WTRUTC at TR provisioning.

In one example, the tracking report may be triggered by the TRF 502a. In another example, the tracking report may be trigger at the alternate tracking source 502b. In a first example, the TRF may send a tracking report notification 502a to an alternate tracking source, based on an internal event, such as a timer expiration, or receiving a tracking report request from a NF/AF/WTRU. The TRF may send the tracking report trigger to an interworking gateway and/or an AF and/or a PEGC/PEMC and/or an aIoT access network and/or a tracking WTRU, depending on which ones are functioning as alternate tracking sources.

In a second example, an alternate tracking source may determine itself to trigger the tracking report request by detecting an internal event 502b, such as a timer expiration, or a change related to connectivity with the tracked WTRU (e.g., the tracked WTRU has connected or disconnected), or a detection of the WTRU presence.

The tracking report request 502c may include any WTRU tracking information, or may contain tracking information that is related to the report triggering source. For example, if the TRF triggered the report 502a, the tracking report notification may indicate which tracking information is required by the TRF, and the alternate tracking source may include only the required tracking information in the tracking report request. In another example, if the report is triggered at the alternate tracking source 502b, the tracking report request may include only tracking information related to the event detected at the alternate tracking source.

In one example, the alternate tracking source may be an interworking gateway. In this example, the tracking report request may indicate one or more of: information about the reporting interworking gateway, information about the WTRU connectivity state with the interworking gateway, information about the connection time/duration, or information about the WTRU IP address in the interworked network.

In one example, the alternate tracking source may be an AF. In this example, the tracking report request may indicate one or more of: information about the reporting AF identifier, information about the WTRU connectivity state with the AF, information about the connection time/duration, information about the WTRU IP address, information about the session with the AF.

In one example, the alternate tracking source may be a PEGC/PEMC. In this example, the tracking report request may indicate one or more of: information about the reporting PEGC/PEMC, information about the PIN (e.g., PIN identifier, PIN profile, etc.), information about the WTRU connectivity state with the PEGC, information about the connection time/duration, or information about the WTRU IP address in the PIN.

In one example, the alternate tracking source may be an aIoT AN. In this example, the tracking report request may indicate one or more of: information about the reporting aIoT AN, information about the WTRU location obtained via the aIoT command triggering (e.g., GPS location), or information about the connectivity state.

For example, if the alternate tracking source is a tracking WTRU, the tracking report request may indicate one or more of: information about the reporting tracking WTRU identifier, information about the tracking WTRU location, information about the WTRU connectivity state with the tracking WTRU, information about the connection time/duration, information about the WTRU IP address, or information about the tracked WTRU detection method (e.g., the tracked WTRU is connected to the tracking WTRU, has been sensed by the tracking WTRU, etc.).

Upon receiving the tracking report request, the TRF may update the WTRU tracking information at the TRF and/or at the UDM/UDR and may send a tracking notification to subscribed consumers 503.

The TRF may send a tracking report response 504 to the alternate tracking source.

It can be appreciated that the TR subscription and notification procedure described in step 1, 501 and step 3, 503 may be achieved following a request/response model, as it was described in the previous example in FIG. 4.

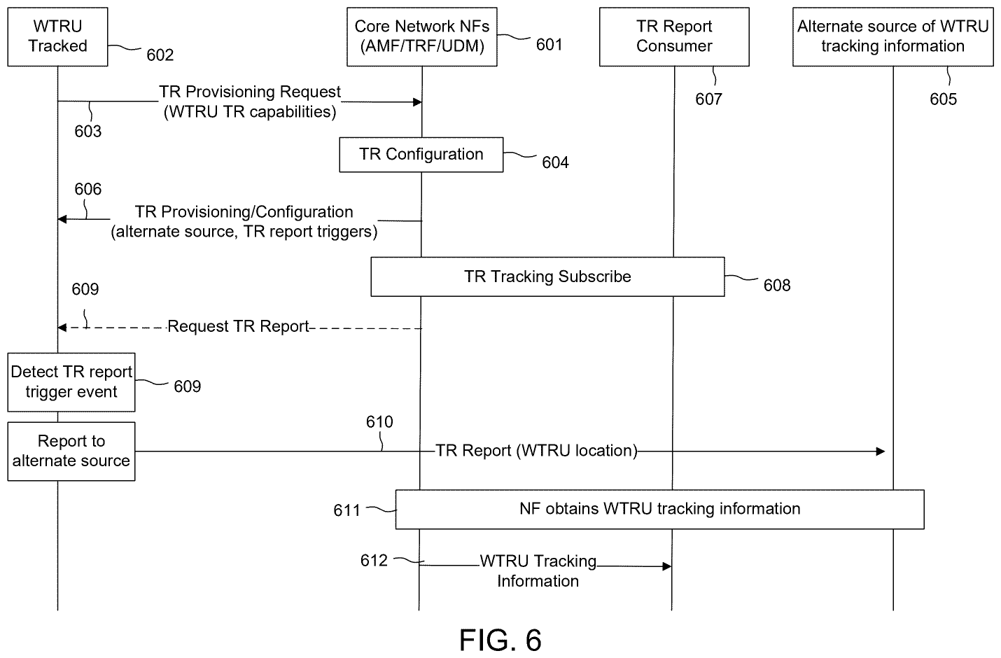

FIG. 6 illustrates an example of a tracking and reachability (TR) procedure when using an alternate source of WTRU tracking.

In the example in FIG. 6, a network function (NF) 601 in a core network (CN) may support WTRU tracking and reachability functionality. In one example, the NF 601 may be a tracking and reachability function (TRF) in the CN. In another example, the NF 601 may be part of an access and mobility function (AMF) in the CN. The NF 601 may be pre-configured with its own TR capabilities.

A WTRU 602 may send, to the NF 601, a TR provisioning request 603. The TR provisioning request 603 may include the WTRU TR capabilities. The WTRU TR capabilities may include the WTRU capability of tracking from an alternate source.

The NF 601 may obtain information from UDM in the CN and may determine a TR configuration 604 for the WTRU 602. The WTRU TR configuration 604 may include an identification of an alternate source 605 of WTRU tracking and a condition to trigger the WTRU to provide tracking information to the alternate source of WTRU tracking. The NF 601 may send the configuration 606 to the WTRU 602. The alternate source of WTRU tracking 605 may be an interworking gateway, an application function, or another WTRU. The interworking gateway may be a non-3GPP interworking function (N3IWF), a trusted non-3GPP gateway function (TNGF), trusted W-LAN interworking function (TWIF), or wireline access gateway function (W-AGF).

The NF 601 may receive, from a TR consumer 607, a request to subscribe 608 to tracking information associated with the WTRU 602. The WTRU 602 may detect a TR report triggering event 609. The event may be a request from the NF 601 for a TR report 609. The WTRU 602 may send the TR report with the tracking information 610 to the alternate source of WTRU tracking 605. The NF 601 may obtain the WTRU tracking information 611 from the alternate source of WTRU tracking 605. The NF 601 may send the WTRU tracking information 612 to the TR consumer 607.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method to be performed by a network function (NF) in a core network, wherein the NF is configured with NF tracking and reachability (TR) capabilities, the method comprising:
receiving WTRU TR capabilities of a first WTRU, wherein the WTRU TR capabilities include capability of tracking from an alternate source;
sending, to the first WTRU, based on the WTRU TR capabilities and the NF TR capabilities, WTRU TR configuration, wherein the WTRU TR configuration includes identification of an alternate source of WTRU tracking information;
sending, to the alternate source of WTRU tracking information, a request for tracking information associated with the first WTRU;
receiving, from the alternate source of WTRU tracking information, tracking information associated with the first WTRU.

2. The method of claim 1, wherein the WTRU TR configuration further includes a condition to trigger the first WTRU to provide tracking information to the alternate source of WTRU tracking information.

3. The method of 1, wherein the WTRU TR configuration further includes an identifier of the NF.

4. The method of claim 1, further comprising:
receiving, from a TR consumer, a request to subscribe to tracking information associated with the first WTRU; and
sending, to the TR consumer, upon receiving tracking information associated with the first WTRU from the alternate source of WTRU tracking information, tracking information associated with the first WTRU.

5. The method of claim 1, wherein the alternate source of WTRU tracking information comprises one of: an interworking gateway, an application function, or a second WTRU.

6. The method of claim 5, wherein the interworking gateway comprises one of: a non-3GPP interworking function (N3IWF), a trusted non-3GPP gateway function (TNGF), trusted W-LAN interworking function (TWIF), or wireline access gateway function (W-AGF).

7. A network function (NF) in a core network, wherein the NF is configured with NF tracking and reachability (TR) capabilities, the NF configured to:
receive WTRU TR capabilities of a first WTRU, wherein the WTRU TR capabilities include capability of tracking from an alternate source;
send, to the first WTRU, based on the WTRU TR capabilities and the NF TR capabilities, WTRU TR configuration, wherein the WTRU TR configuration includes identification of an alternate source of WTRU tracking information;
send, to the alternate source of WTRU tracking information, a request for tracking information associated with the first WTRU;
receive, from the alternate source of WTRU tracking information, tracking information associated with the first WTRU.

8. The NF of claim 7, wherein the WTRU TR configuration further includes a condition to trigger the first WTRU to provide tracking information to the alternate source of WTRU tracking information.

9. The NF of claim 7, wherein the WTRU TR configuration further includes an identifier of the NF.

10. The NF of claim 7, further configured to:
receive, from a TR consumer, a request to subscribe to tracking information associated with the first WTRU; and
send, to the TR consumer, upon receiving tracking information associated with the first WTRU from the alternate source of WTRU tracking information, tracking information associated with the first WTRU.

11. The NF of claim 7, wherein the alternate source of WTRU tracking information comprises one of: an interworking gateway, an application function, or a second WTRU.

12. The NF of claim 11, wherein the interworking gateway comprises one of: a non-3GPP interworking function (N3IWF), a trusted non-3GPP gateway function (TNGF), trusted W-LAN interworking function (TWIF), or wireline access gateway function (W-AGF).

13. A method performed by a wireless receive and transmit unit (WTRU), the method comprising:
sending, to a network, WTRU tracking and reachability (TR) capabilities;
receiving, from the network, in response to sending the WTRU TR capabilities, WTRU TR configuration, wherein the WTRU TR configuration includes identification of an alternate source of WTRU tracking information and a condition to trigger the WTRU to provide tracking information to the alternate source of WTRU tracking information; and
sending, to the alternate source of WTRU tracking information, based on determining that the condition is met, WTRU tracking information.

14. The method of claim 13, wherein the alternate source of WTRU tracking information comprises one of: an interworking gateway, an application function, or a WTRU.

15. The method of claim 14, wherein the interworking gateway comprises one of: a non-3GPP interworking function (N3IWF), a trusted non-3GPP gateway function (TNGF), trusted W-LAN interworking function (TWIF), or wireline access gateway function (W-AGF).

16. The method of claim 13, wherein the WTRU tracking capabilities comprise at least one of: self-tracking capability, capability of tracking from an alternate source, or capability to track different WTRU.

17. The method of claim 16, wherein the capability of tracking from an alternate source includes identification of one or more alternate sources of tracking information.

18. The method of claim 16, wherein the capability to track different WTRU includes identification of one or more different WTRUs.
